(19) United States
(12) Patent Application Publication
(10) Pub. No.: US 2014/0197647 A1
(43) Pub. Date: Jul. 17, 2014

(54) DOOR LATCH AND BAR LOCKING MECHANISM FOR A ROOFTOP AIR CONDITIONING UNIT

(71) Applicant: Carrier Corporation, Farmington, CT (US)

(72) Inventors: Eugene Duane Daddis, JR., Manlius, NY (US); Scott Philip Mautz, Baldwinsville, NY (US)

(73) Assignee: Carrier Corporation, Farmington, CT (US)

(21) Appl. No.: 13/938,583

(22) Filed: Jul. 10, 2013

Related U.S. Application Data
(60) Provisional application No. 61/699,417, filed on Sep. 11, 2012.

(51) Int. Cl. E05C 19/08

(52) U.S. Cl. CPC E05C 19/08
USPC 292/257

(57) ABSTRACT

A latching mechanism for sealing an access panel to a sidewall includes a cam rod pivotable between a first position and a second position. The cam rod includes a handle and at least one generally U-shaped bend configured to engage a surface of the access panel when in the first position. The latching mechanism also includes a latch mounted to the access panel. The latch is rotatable between a third position and a fourth position. The latch is configured to engage and apply a force to the handle of the cam rod when in the fourth position.

### CROSS-REFERENCE TO RELATED APPLICATIONS

The application claims the benefit of U.S. provisional patent application Ser. No. 61/699,417, filed Sep. 11, 2012, the entire contents of which are incorporated herein by reference.

### BACKGROUND OF THE INVENTION

The invention relates generally to an air conditioning system and, more particularly, to a latching mechanism for an access panel of an air conditioning system.

When installed outdoors, heating, ventilation, and air conditioning equipment (HVAC equipment) is often housed within a sheet metal enclosure to protect the equipment from the weather. Such an enclosure typically comprises a cabinet with an access panel that can be readily opened or removed to provide access into the cabinet for inspecting or servicing the equipment. A gasket may be installed around the perimeter of the access panel to provide a weather tight seal between the panel and the cabinet.

Conventional latching mechanisms are used to seal the access panel in a closed position. However, access panels are typically large and heavy, such that a significant force is required to properly seal the access panel to prevent rain and other moisture from entering the interior of the housing. If the HVAC equipment is not adequately protected from its environment, the equipment may malfunction or corrode. Conventional latching mechanisms that adequately seal the access panel are large, cumbersome, and expensive to manufacture.

### BRIEF DESCRIPTION OF THE INVENTION

According to one embodiment of the invention, a latching mechanism for sealing an access panel to a sidewall includes a cam rod pivotable between a first position and a second position. The cam rod includes a handle and at least one generally U-shaped bend. A portion of the U-shaped bend is configured to engage a surface of the access panel when in the first position. The latching mechanism also includes a latch mounted to the access panel. The latch is rotatable between a third position and a fourth position. The latch is configured to engage and apply a force to the handle when in the fourth position.

According to another embodiment of the invention, a method for sealing an access panel to an adjacent sidewall is provided including pivoting the access panel to a closed position. A cam rod having a handle and at least one generally U-shaped bend is rotated from a first position to a second position. In the second position a portion of the at least one U-shaped bend contacts a surface of the access panel. A latch is rotated from a third position to a fourth position. In the fourth position, the latch engages the handle of the cam rod and applies a force thereto.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a front view of a portion of a housing and a latching mechanism according to an embodiment of the invention;

FIG. 2 is a detailed view of a portion of a cam rod according to an embodiment of the invention;

FIG. 3 is a portion of a cam rod according to an embodiment of the invention;

FIG. 4 is a front view of another latching mechanism according to an embodiment of the invention;

FIG. 5 is a front view of another latching mechanism according to an embodiment of the invention;

FIG. 6 is a top view of another latching mechanism in a first position according to an embodiment of the invention; and

FIG. 7 is a side view of the latching mechanism of FIG. 5 in a second position.

### DETAILED DESCRIPTION OF THE INVENTION

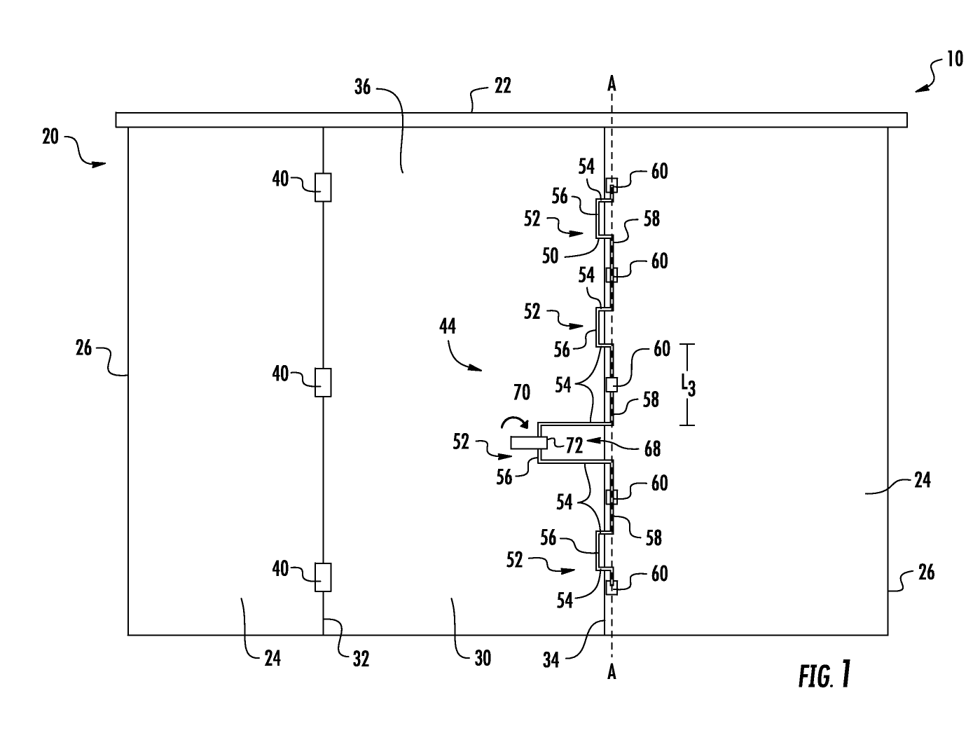

Referring now to FIG. 1, a portion of a housing 10 mounted to the rooftop of a building is illustrated. A cabinet 20 includes a top cover 22, a pair of opposing sidewalls 24 (only one of which is illustrated), and a pair of opposing end walls 26. An access panel or door 30 is formed in one of the sidewalls 24 so that a person, such as a mechanic for example, may gain access to the interior of the housing 10 formed by the cabinet 20 and access panel 30. In one embodiment, heating, ventilation, and air conditioning (HVAC) equipment for the building may be stored within the interior of the housing 10.

The access panel 30 may extend over the entire height of the sidewall 24, or alternatively, may extend over only a portion of the height of the sidewall 24. A plurality of hinges 40 pivotally couple a first edge 32 of the access panel 30 to an adjacent portion of a sidewall 24. A latching mechanism 44 is used to seal the access panel 30 to the adjacent sidewall 24. The latching mechanism 44 includes a cam rod 50 disposed near the second edge 34 of the access panel 30. The cam rod 50 is pivotally mounted to the sidewall 24 adjacent the second edge 34 with at least one clamp 60 so that the cam rod 50 may pivot about an axis A, between a first position generally parallel to the plane of the access panel 30, shown in FIG. 1, and a second position generally perpendicular to the plane of the access panel 30. The cam rod 50 may be formed from a wire having a diameter in the range of about 0.25 inches to about 1 inch. In one embodiment, the cam rod 50 is formed from a wire having a diameter of about ⅜ of an inch. The cam rod 50 may be galvanized or include some other coating to prevent oxidation and corrosion of the wire as a result of exposure to the weather.

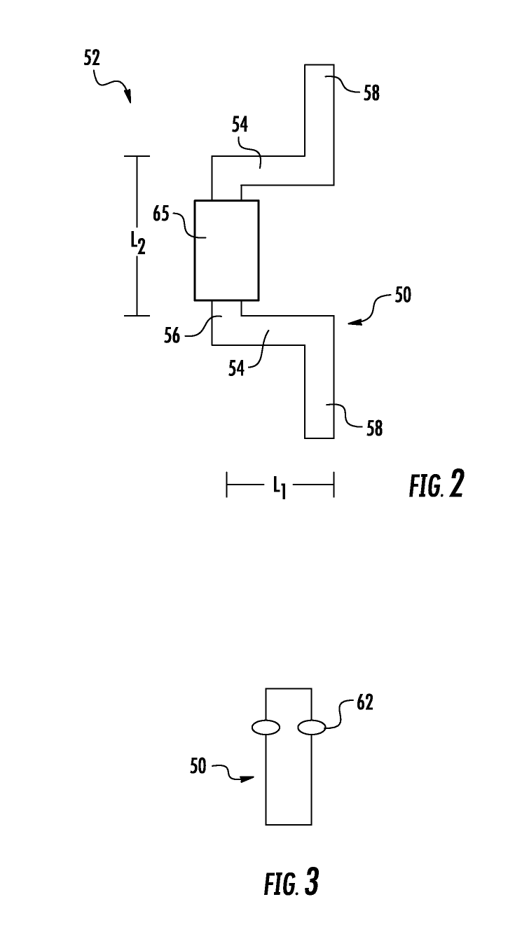

The cam rod 50 extends generally linearly, parallel to, and along the length of the second edge 34 of the access panel 30. In one embodiment, the cam rod 50 includes a plurality of generally U-shaped bends 52 positioned at intervals along the length of the cam rod 50. As shown in more detail in FIG. 2, each U-shaped bend 52 includes two parallel and equal sides 54 and a bottom portion 56 connecting the two sides 54. When the cam rod 50 is in the first position, the U-shaped bends 52 extend in the direction of the access panel 30 such that a portion of each U-shaped bend 52 is adjacent the surface 36 of the access panel 30. The U-shaped bends 52 are configured to apply a force to the surface 36 of the access panel 30 to retain the access panel 30 in a closed, sealed position relative to the container 20. In one embodiment, bumpers 65 surround part of the bottom portions 56 of the U-shaped bends 52 to prevent the cam rod 50 from damaging the surface 36 of the access panel 30 when in the first position. The clamps 60 mounting the cam rod 50 to the sidewall 24 may be centrally positioned at the linear portion 58 of the cam rod 50 between each of the U-shaped bends 52. At least one clamp 60 may include a recess (not shown) for receiving a complementary knurl 62 (see FIG. 3) on the cam rod 50, such as adjacent an end of the cam rod 50 for example. The engagement of the knurl 62 within the recess will prevent the cam rod 50 from moving vertically relative to the sidewall 24 as the cam rod 50 is rotated about axis A between the first position and the second position.

The latching mechanism 44 also includes a latch 70 rotatably mounted to the surface 36 of the access panel 30. The latch 70 pivots in the plane of the access panel 30 between a first position, shown in FIG. 1, and a second position, perpendicular to the first position. The latch 70 is configured to engage a portion, such as a bottom portion 56 for example, of one of the U-shaped bends 52 to retain the cam rod 50 in the first position. The latch 70 may include a biasing mechanism 71, for example, a spring that biases the latch 70 into engagement with a portion of the cam rod 50. In one embodiment, the biasing mechanism biases the latch 70 into the first position.

The cam rod 50 may be arranged so that in the first position, the cam rod is oriented at small angle relative to the surface 36 of the access panel 30. In one embodiment, the cam rod 50 is arranged at about a 5 degree angle to the access panel 30 when in the first position. By arranging the cam rod 50 at a slight angle, the latch 70 applies a force to the portion of the cam rod 50 that the latch 70 engages. This force is transmitted through the bumpers 65 and bottom portions 56 of the cam rod 50 to the surface 36 of the access panel 30. If the latch 70 is rotated to the second position, out of engagement with one of the U-shaped bends 52, the cam rod 50 may be pivoted to a second position, perpendicular to the plane of the access panel 30, thereby allowing the access panel 30 to open and pivot freely about its hinges 40.

In one embodiment, the cam rod 50 includes a U-shaped bend that functions as a handle 68 for rotating the cam rod 50 between the first position and second position. This handle 68 is configured to engage the latch 70 when the cam rod 50 is in the first position. The U-shaped bend 52 that functions as the handle 68 may be a different size than the remainder of the plurality of U-shaped bends. In one embodiment, the sides 54 of the U-shaped bend 52 that forms the handle 68 have a length L1 in the range of about 6 inches to about 15 inches, whereas the sides 54 of the remainder of U-shaped bends 52 have a length L1 in the range of about 1 inch to about 5 inches (see FIG. 2). The length L2 of the bottom portion 56 of each of the U-shaped bends 52 including handle 68 may be equal and in the range of about 2 inches to about 8 inches (see FIG. 2). However, the dimensions of the U-shaped bend 52 that forms the handle 68 are dependent on the position of the latch 70 relative to the access panel 30. The linear portion 58 of the cam rod 50 between the intervals of U-shaped bends 52 may have a length L3 in the range of about 4 inches to about 12 inches (see FIG. 1).

The cam rod 50 functions as a lever. By increasing the length of the sidewalls 54 of the handle 68, the torque and deflection of the cam rod 50 are increased, causing the bumpers 65 and the bottom portions 56 of the other U-shaped bends 52 to apply a greater force to the surface of the access panel 30.

To close and seal the access panel 30, the access panel 30 is pivoted about its hinges 40 to a position coplanar with the sidewall 24. The handle 68 of the cam rod 50 is used to rotate the cam rod 50 from a second position, generally perpendicular to access panel 30, to a first position, generally parallel to the access panel 30. The latch 70 is then rotated relative to the access panel 30 until the latch 70 engages a portion of the handle 68 to seal the access panel 30. To open the access panel 30, the latch 70 is pivoted to a second position out of engagement with the handle 68 of the cam rod 50. The cam rod 50 is then rotated about axis A back to a second position, out of the range of motion of the access panel 30. An operator may then apply a force to the latch 70 to pivot the access panel 30 about its hinges 40 out of the plane of the sidewall 24.

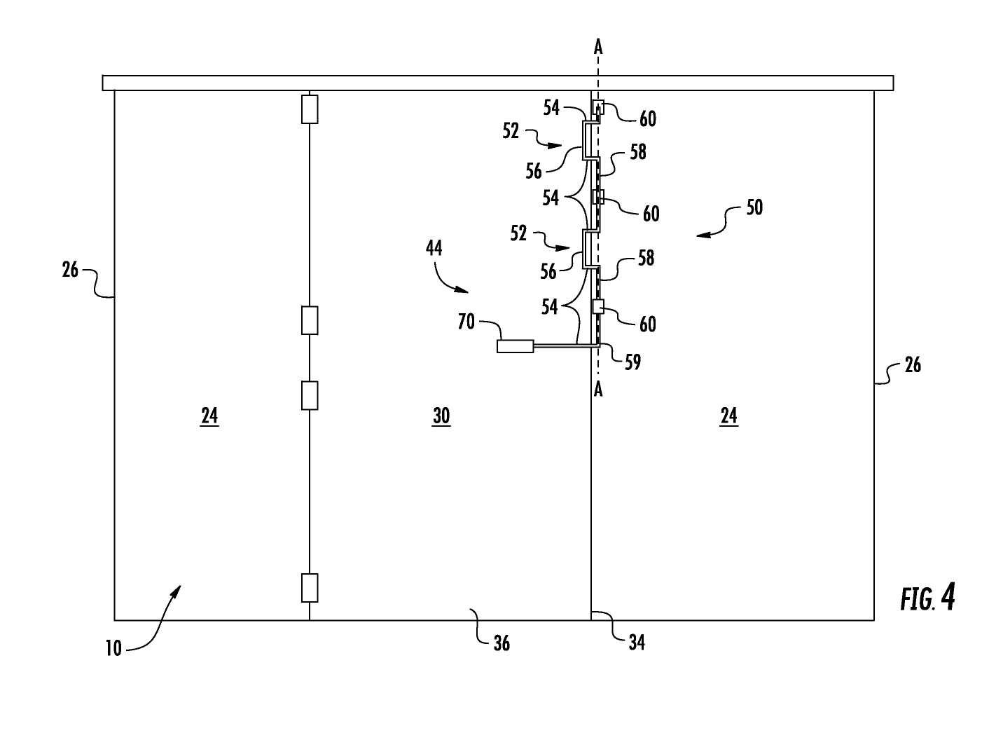

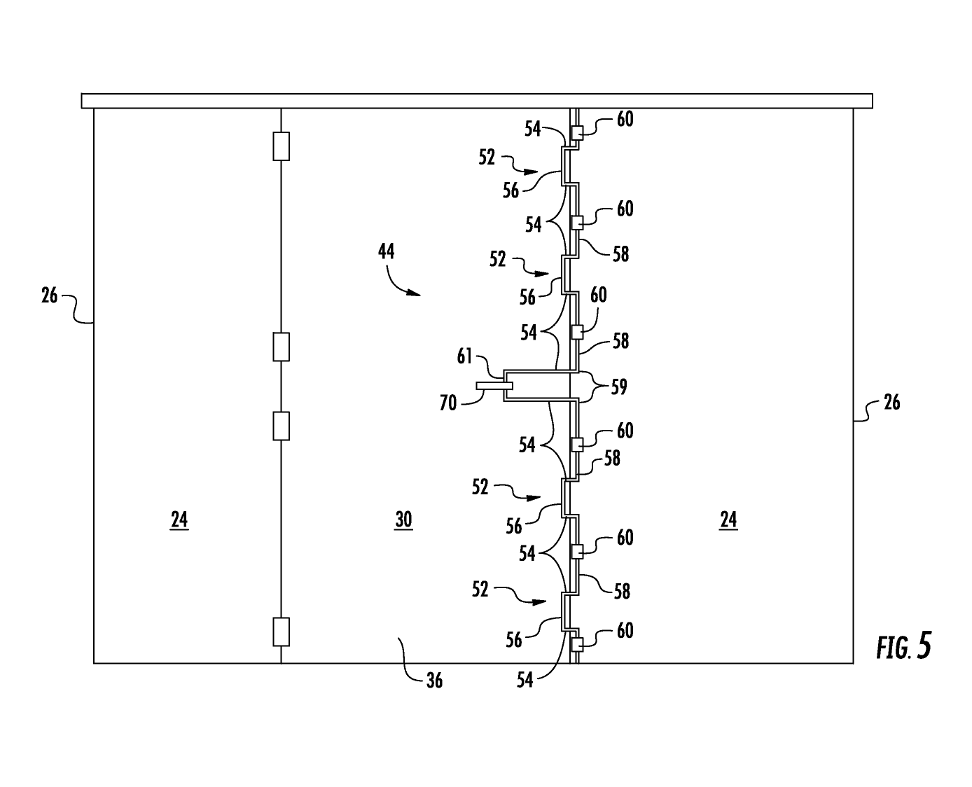

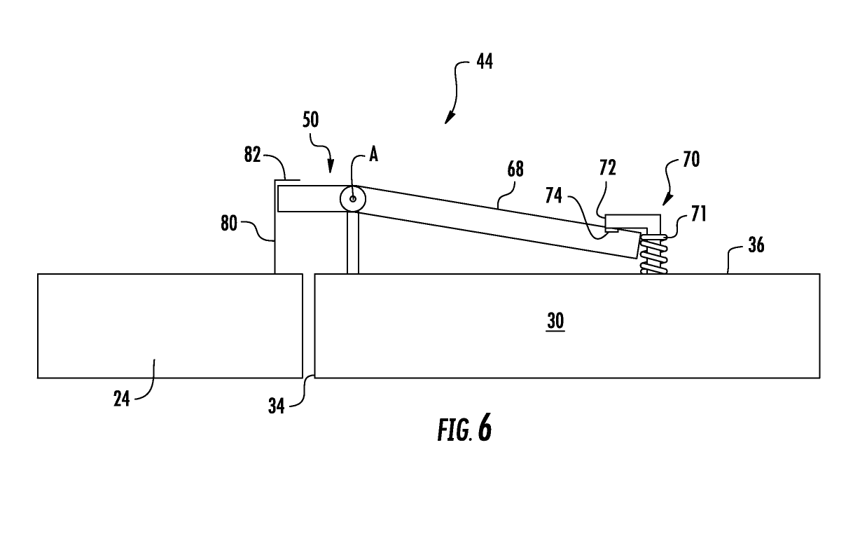

In another embodiment, illustrated in FIG. 4, a cam rod 50 extends over less than half of the length of the access panel 30. By reducing the length of the cam rod 50, the cam rod 50 is easier to manufacture and is less susceptible to torsional deflection. The end 59 of a cam rod 50 near the middle of the access panel 30 includes at least an extended side 54 that functions as a handle 68 and engages the latch 70. As shown in FIG. 5, multiple cam rods 50 may be mounted to the sidewall 24 adjacent the second edge 34 of the access panel 30, to generate a sealing force across the whole length of the access panel 30. In one embodiment, two identical cam rods 50, 50′ are axially aligned adjacent the second edge 34 of the access panel 30 such that the handle 68 of each cam rod 50 can be engaged by a single latch. A connector device 61 may extend between the side 54 of the first cam rod 50 and the side 54 of the second cam rod 50′ to form a general U-shape. Alternatively, the latch 70 may be wide enough such that when the cam rods 50, 50′ are in a first position, the handles 68 of both cam rods 50, 50′ engage the latch.

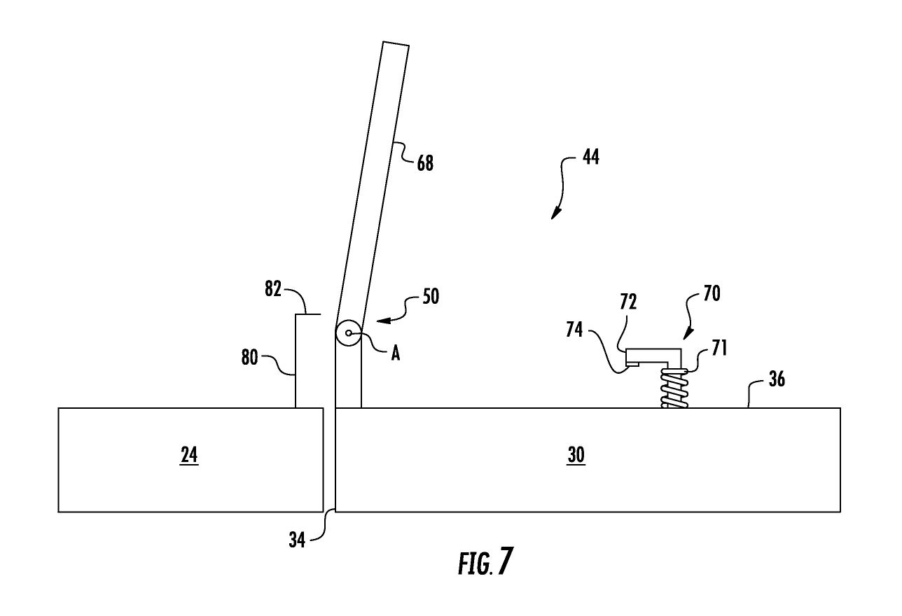

In yet another embodiment, illustrated in FIGS. 6 and 7, a cam rod 50, as previously described, is pivotally mounted to the access panel 30 adjacent the second edge 34. A stop 80 extends perpendicularly from the sidewall 24 near the second edge 34 of the access panel 30. The end 82 of the stop 80 extends parallel to and in the direction of the access panel 30. When the access panel 30 is closed and the cam rod 50 and latch 70 are in a first position, the biasing force of the latch 70 causes the cam rod 50 to pivot about the access panel 30 such that a portion of the cam rod 50 engages and applies a torque to the end 82 of the stop 80. Once the latch 70 is rotated out of engagement with a portion of the cam rod 50, such as handle 68 for example, the cam rod 50 may be pivoted about axis A, out of the plane of the access panel 30, to prevent the cam rod 50 from contacting a portion of the stop 80 as the access panel 30 is opened. In one embodiment, axis A is elevated away from the access panel 30 so that the cam rod 50 may rotate to a position perpendicular to the access panel 30.

The cam rod 50 of the described latching mechanism 44 is easy to manufacture and cost effective. In addition, by using the cam rod 50 as a lever, a mechanical advantage is achieved by increasing the length U-shaped bend that forms the handle 68 compared to the other U-shaped bends of the cam rod 50. By increasing the length of the sidewalls 54 of the handle 68, the biasing force that the latch 70 must apply to the cam rod 50 to adequately seal the access panel 30 is reduced.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A latching mechanism for sealing an access panel to an adjacent sidewall, comprising:
a cam rod pivotable between a first position and a second position, the cam rod including a handle and at least one generally U-shaped bend, wherein when the cam rod is in the first position, the cam rod is arranged at an angle to the access panel and a portion of the U-shaped bend is configured to engage a surface of the access panel; and
a latch mounted to the access panel and rotatable between a third position and a fourth position, wherein the latch is configured to engage and apply a force to the handle when in the fourth position.

2. The latching mechanism according to claim 1, wherein a biasing mechanism biases the latch into the fourth position.

3. The latching mechanism according to claim 1, wherein the cam rod includes a plurality of generally U-shaped bends spaced at intervals.

4. The latching mechanism according to claim 3, wherein each U-shaped bend includes two generally equal sides and a bottom portion connecting the two sides.

5. The latching mechanism according to claim 3, wherein a bumper surrounds part of the bottom portion of the plurality of U-shaped bends.

6. The latching mechanism according to claim 3, wherein one of the plurality of U-shaped bends forms a handle configured to engage the latch.

7. The latching mechanism according to claim 6, wherein the handle is formed from a U-shaped bend having sides longer than the remainder of the plurality of U-shaped bends.

8. The latching mechanism according to claim 3, wherein the cam rod is mounted to the sidewall adjacent an edge of the access panel.

9. The latching mechanism according to claim 8, wherein a plurality of clamps surrounds a portion of the cam rod between the intervals of U-shaped bends.

10. The latching mechanism according to claim 1, further comprising a stop extending from the sidewall adjacent an edge of the access panel, the stop having an end configured to engage a portion of the cam rod in a first position.

11. The latching mechanism according to claim 10, wherein the cam rod is mounted to the access panel adjacent the edge.

12. The latching mechanism according to claim 1, wherein the cam rod is manufactured from wire having a diameter in a range of about 0.25 inches and about 1 inch.

13. A method for sealing an access panel to an adjacent sidewall comprising:
pivoting the access panel to a closed position;
rotating a cam rod having a handle and at least one generally U-shaped bend from a first position to a second position, wherein in the second position, the cam rod is arranged at an angle to the access panel such that a portion of the at least one U-shaped bend is configured to contact a surface of the access panel;
rotating a latch from a third position to a fourth position, wherein in the fourth position the latch engages the handle of the cam rod and applies a force thereto.

14. The method according to claim 13, wherein the cam rod is mounted to the sidewall adjacent the access panel;

15. The method according to claim 13, wherein the cam rod is mounted to the access panel adjacent an edge.

16. The method according to claim 15, wherein application of the force to the handle causes a portion of the cam rod to engage a stop extending from the sidewall adjacent the access panel.

17. The method according to claim 13, wherein a biasing mechanism biases the latch into the fourth position.

18. The method according to claim 18, wherein the handle is formed by from a U-shaped bend having sidewalls longer than the remainder of the plurality of U-shaped bends.
